(19) United States
(12) Patent Application Publication
(10) Pub. No.: US 2012/0166538 A1
(43) Pub. Date: Jun. 28, 2012

(54) VIRTUAL SMART HOME SYSTEM, SERVER, HOME GATEWAY BASED ON CLOUD COMPUTING AND SMART HOME SERVICE METHOD

(75) Inventors: Young Sung SON, Daejeon (KR); Jun Hee PARK, Daejeon (KR); Ji Yeon SON, Daejeon (KR); Kyeong Deok MOON, Daejeon (KR)

(73) Assignee: Electronics and Telecommunications Research Institute, Daejeon (KR)

(21) Appl. No.: 13/335,301

(22) Filed: Dec. 22, 2011

(30) Foreign Application Priority Data
Dec. 23, 2010 (KR) 10-2010-0133784

(51) Int. Cl. G06F 15/16

(52) U.S. Cl. 709/204

(57) ABSTRACT

A smart home system based on a cloud computing includes: a home gateway connecting a home network device to an external network, the home network device being connected to a home network at each home. The system further includes and a cloud server, connected to the home gateway, for collecting contents information stored in the home network device and resource information of the home network information and performing a unified management of the contents information and the resource information at the each home.

### CROSS-REFERENCE(S) TO RELATED APPLICATION(S)

The present invention claims priority of Korean Patent Application No. 10-2010-0133784, filed on Dec. 23, 2010, which is incorporated herein by reference.

### FIELD OF THE INVENTION

The present invention relates to a smart home device; and more particularly, to a virtual smart home system, a server, a home gateway based on cloud computing and a smart home service method which realize a unified management for contents generated from each home and an instant seamless service by providing a home server service via a server operated stably by a professional management in a complex server or Internet data center (IDC) without locating a home server at home in a home network service of a home network environment where a plurality of devices are installed.

### BACKGROUND OF THE INVENTION

Generally, a home network system configures a home network at home. The home network system includes a home network device for control connected to the home network, a home gateway connecting the home network with an external network, a complex server control whole home network, a home network interface between them and a message protocol.

In addition, each of devices has a specific function. Service is performed by connection of the devices.

The function list of the device has its standard and thus the home network has complex construction. As a result, the home network service has a difficulty in performing the service and providing compatibility.

Meanwhile, a smart device such as a smart TV, a smart pad, a smart home appliance and the like, is installed at home and a smart service is provided by using the smart device. However, the smart device plays role in providing a user with information or entertainment and collecting information around the user.

Thus, in order to provide the user with service by using the conventional smart device, home server function which manages, calculates and provides information for the service should be operated in the background of the smart device.

The home server function for traditional home automation is performed by the home gateway or a wall pad. However, the home gateway or the wall pad has limitation for playing a role of the home server for the smart home service which will be extended by the smart device.

### SUMMARY OF THE INVENTION

In view of the above, the present invention provides a virtual smart home system, a server, a home gateway based on cloud computing and a smart home service method which realize a unified management for contents generated from each home and an instant seamless service by providing a home server service via a server operated stably by a professional management in a complex server or internet data center (IDC) without locating a home server at home in a home network service of a home network environment where a plurality of devices are installed.

The present invention further provides a virtual smart home system, a server, a home gateway based on cloud computing and a method thereof which extend home network service environment, where a plurality of devices connected by a home network is installed and a system for control the devices and various services using the system are installed, to a cloud server, divide the service into a cloud service server and a local service client, and make interworking between them via overlay network.

The present invention further provides an effective home network service method for extending a home network service area by providing a service execution device such as a smart phone with seamless operation and extending practical ability by connecting a home network construction to a cloud server and dividing execution of the service into a server and a client.

In accordance with a first aspect of the present invention, there is provided a smart home system based on a cloud computing including: a home gateway connecting a home network device to an external network, the home network device being connected to a home network at each home; and a cloud server, connected to the home gateway, for collecting contents information stored in the home network device and resource information of the home network information and performing a unified management of the contents information and the resource information at the each home.

In accordance with a second aspect of the present invention, there is provided a server apparatus based on a cloud computing including: a virtual home server for collecting contents information stored in a home network device and a resource information of the home network device from a home gateway connecting the home network device at home; an overlay message module for receiving or transmitting the contents information or the resource information via the home gateway and an overlay messaging layer; and a cloud server for controlling a cloud service, the cloud service performing a unified management of the contents information and the resource information transmitted from the virtual home server.

In accordance with a third aspect of the present invention there is provided a home gateway based on a cloud computing including: a local service client for collecting contents information stored in a home network device connected to a home network at home and resource information of the home network device; a home server for providing the contents information and the resource information collected from the local service client to a cloud server, the cloud server providing a cloud service; an overlay message module for generating and transmitting to the cloud server an overlay message having the contents information and the resource information; and a home networking module connected to the home network for interfacing data.

In accordance with a fourth aspect of the present invention, there is provided a smart home service method based on a cloud computing. The method includes: connecting a home network device to an external network by a home gateway, the home device being connected to a home network at home; collecting a contents information stored in the home network device and a resource information of the home device by a cloud server implemented in the external network; and performing a unified management of the collected contents information and the resource information.

### BRIEF DESCRIPTION OF THE DRAWINGS

The objects and features of the present invention will become apparent from the following description of embodiments, given in conjunction with the accompanying drawings, in which:

FIG. 1 depicts a network of a virtual smart home system based on a cloud computing in accordance with an embodiment of the present invention;

FIG. 2 illustrates an example of an application service which is implemented in a smart home system based on a cloud computing in accordance with the embodiment of the present invention;

FIG. 3 is a specific block diagram of a cloud server and a home gateway in accordance with the embodiment of the present invention;

FIG. 4 shows a specific block diagram of a virtual home server and a local service client in accordance with the embodiment of the present invention;

FIG. 5 illustrates a concept of a cloud service with the embodiment of the present invention; and

FIGS. 6 to 9 are examples of a user interface of a smart display apparatus for a virtual smart home service in accordance with the embodiment of the present invention.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, embodiments of the present invention will be described with reference to the accompanying drawings which form a part hereof.

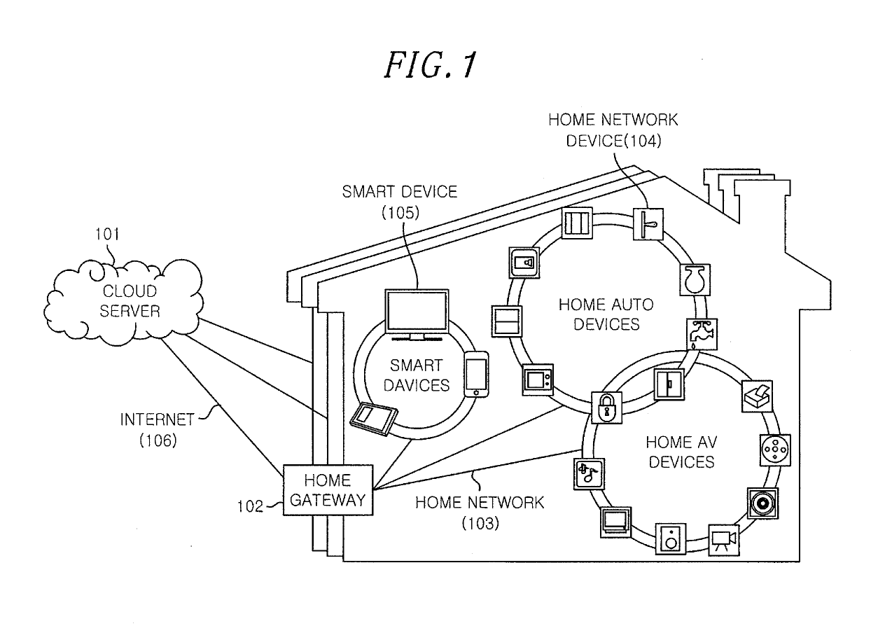

FIG. 1 depicts a network of a virtual smart home system based on a cloud computing in accordance with an embodiment of the present invention.

Referring to FIG. 1, plural kinds of electric devices including home network devices 104 such as a TV, a computer, an AV device, a refrigerator and a microwave oven and the like, and a smart device 105 such as a smart phone is connected to each other via a home network 103.

The home network device 104 and the smart device 105 connected to the home network 103 are connected to a network 106 such as an internet via a home gateway 102 installed at each home. In case of apartment, the network device 104 and the smart device 105 are connected to a complex server controlling the home gateway 102 in each home via the internet 106.

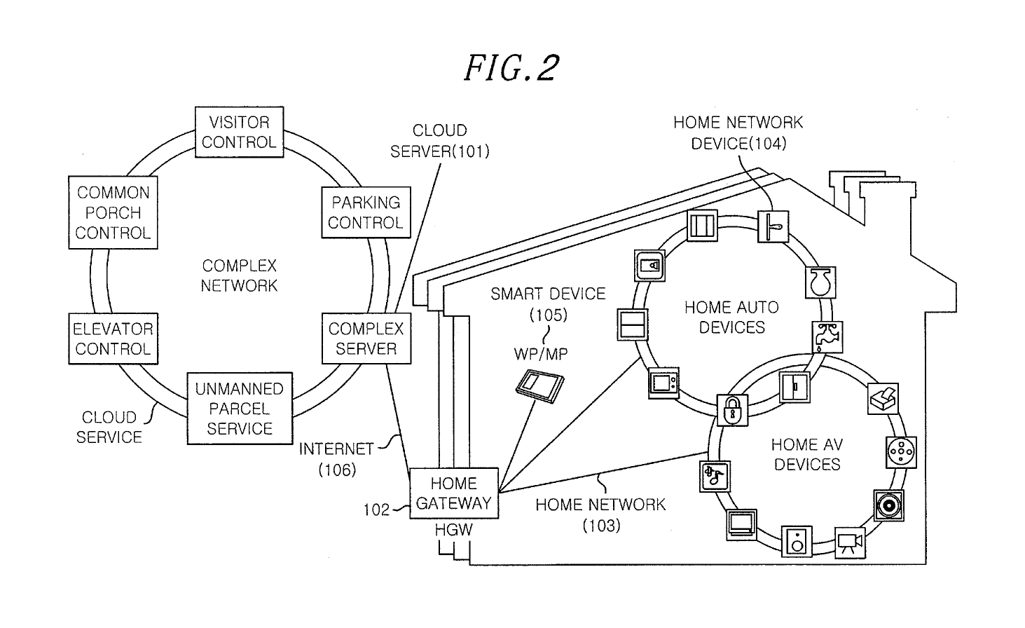

According to the embodiment of the present invention, a cloud server 101 controlling the contents and resources of the home network device 104 of each home in a complex server is implemented and a virtual home server for storing and managing contents stored in the home network device 104 and the resources of the home network device 104 is mounted in the cloud server 101. Thus, as shown in the following FIG. 2, various services using contents stored in each hone can be performed in the complex server in which the cloud server is implemented.

FIG. 2 illustrates an example of an application service which can be implemented in a smart home system based on a cloud computing in accordance with an embodiment of the present invention.

Referring to FIG. 2, the complex server is connected to the home gateway 102 installed in each home via an internet 106. The home gateway 102 is connected to the home network 103 which connects the various home network devices 104 with the smart device 105.

As described in FIG. 1, the cloud server 101 for integratively storing and managing the devices and the contents of the home network 103 at each home is implemented and the virtual home server for searching for, storing and managing the contents stored in each home is mounted in the cloud server 101. The virtual home server communicates with the home gateway 102 in each home actually.

A user living at home such as an apartment can access the cloud server 101 in the apartment complex and the user can search for a picture and a moving picture which is provided publicly from each home. Thus, the user can obtain various information.

In addition, a unified management for the home network device of each home such as the apartment can be performed by connecting the home gateway 102 of each home to the cloud server 101. Thus, various services such as common porch control, visitor control, elevator control, unmanned parcel service, parking control and the like, which the conventional complex server cannot implement, can be provided.

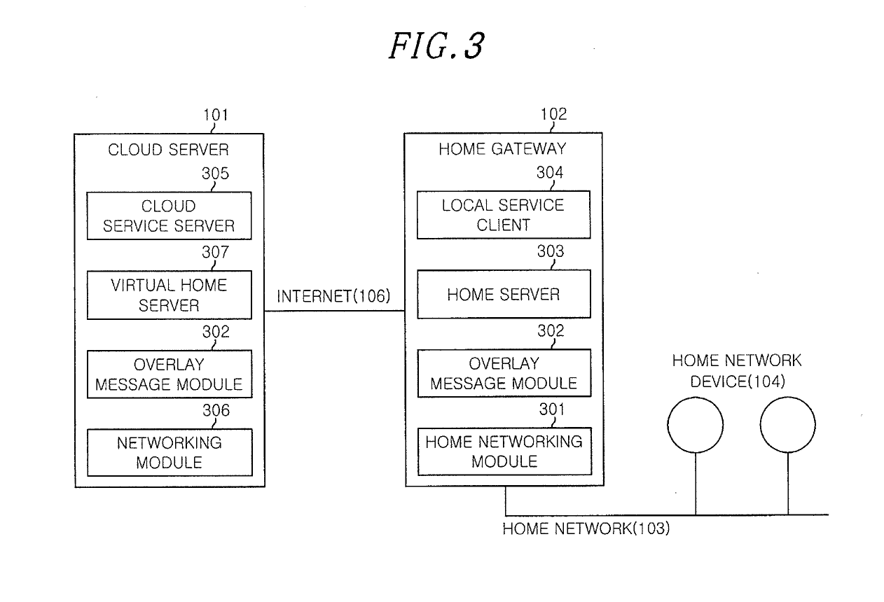

FIG. 3 is a specific block diagram of the cloud server 101 and the home gateway 102 in accordance with the embodiment of the present invention.

The cloud server 101 includes a cloud service server 305, a virtual home server 307, an overlay message module 302 and a networking module 306 and the like

The cloud service server 305 controls various application services provided from the cloud server 101.

The virtual home server 307 receives and stores information for resources and contents existing in each home from the home gateway 102 and organizes and stores contents received from a plurality of home according to the theme of the contents. When the virtual home server 307 receives request for searching for and downloading the information for the content or the resources of the home, the virtual home server 307 searches for the corresponding content or resource and provides the corresponding content or resource.

The overlay message module 302 generate an overlay message from content or resource information transmitted/received between the cloud server 101 and the home gateway 102 and transmits the overlay message to the networking module 306. The networking module 306 is connected to an internet and interface data packet transmitted/received between the cloud server 101 and the home gateway 102.

The home gateway 102 includes a local service client 304, a home server 303, an overlay message module 302, a home networking module 301 and the like

The local service client 304 collects content information stored in the home network device 104 and resource information of the home network device 104 from the home network device 104 connected to the home network 103 and provides the contents information and resource information to the home server 303.

The home server 303 controls the operation of the home gateway 102. In addition, the home server 303 collects contents information or resource information for the home network device 104 connected to the home network 103 by controlling the local service client 304 and provides the contents information or the resource information to the cloud server 101 connected to the internet 106.

The overlay message module 302 generates an overlay message from the contents information or the resource information transmitted/received between the cloud server 101 and the home gateway 102 and transmits the overlay message.

The home networking module 301 is connected to the home network 103 at home and transmits or receives the contents information and the resource information to/from the various home devices 104.

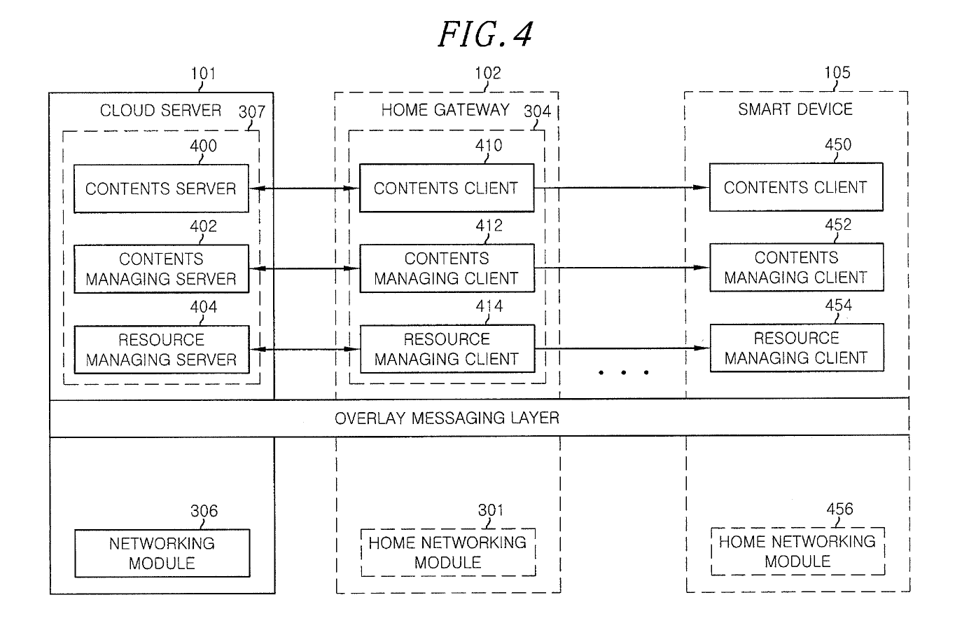

FIG. 4 shows signal transmissions between the virtual home server 307 of the cloud server 101 and the local service client 304 of the home gateway 102. Hereinafter, embodiments of the present invention will be described in detail with reference to FIGS. 3 and 4.

The virtual home server 307 further includes a contents server 400, a contents managing server 402 and a resource managing server 404. The local service client 304 includes a contents client 410, a contents managing client 412 and a resource managing client 414.

The contents server 400 request contents stored in the home network device 104 to the contents client 410 in the local service client 304 and receives collected contents stored in the home network device 104 from the contents client 410.

The contents managing server 402 receives the contents information stored in the home network device 104 from the contents server 400 and manages contents resource information.

The resource managing server 404 requests the resource information of the home network device 104 to the resource managing client 414 in the local service client 304, and receives the resource information of the home network device 104 and manages the resource information.

When the contents client 410 receives a request for the contents stored in the home network device 104 from the contents server 400 in the virtual home server 307, the contents client 410 requests the contents to the contents client 450 of the smart device 105 connected to the home network and provides the received contents to the contents server 400 in the virtual home server 307 according to the request.

The contents managing client 412 manages the contents information stored in the home network device 104 and collected by the contents client 410.

The resource managing client 414 requests the resource information of the home network device 104 to a resource managing client 454 in the smart device 105 connected to the home network 103 and provides the received resource information to the resource managing server 404 in the virtual home server 307 according to the request.

As described above, message transmitted/received between the virtual home server 307, the home gateway 102 and a module of the smart device 105 is transmitted/received via an overlay messaging layer set between the networking module 306 and the home networking module 301.

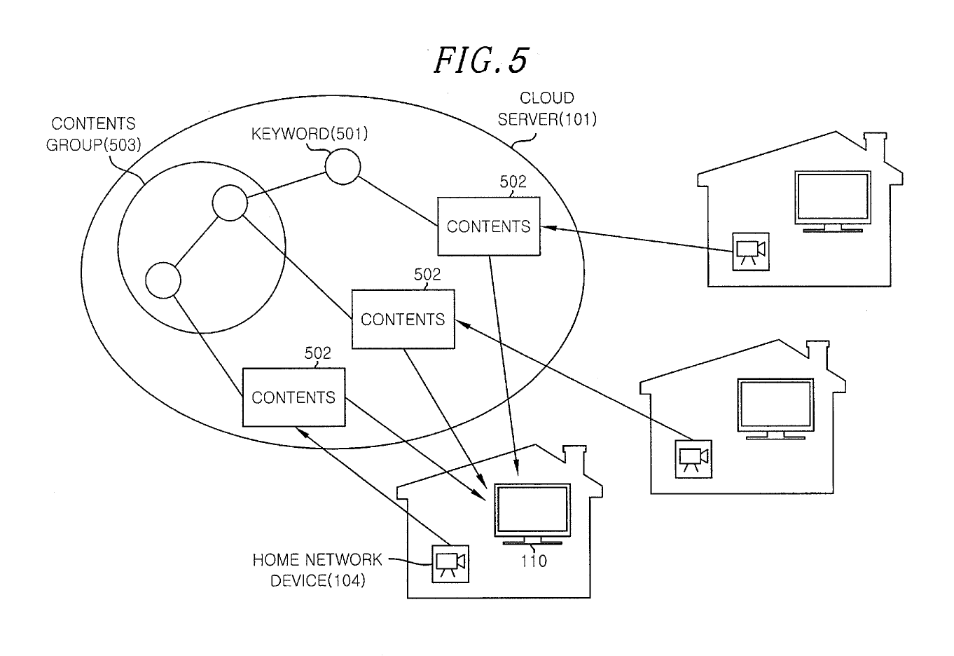

FIG. 5 illustrates a concept of managing contents collected in each home by the cloud server 101 in accordance with the embodiment of the present invention.

Referring FIG. 5, for example, in case the home network device 104 is a camcorder, the camcorder of each home stores pictures or moving pictures taken by the user and the contents such the pictures and the moving pictures are managed by a device such as a smart phone for managing the contents information or the resource information at through the home network.

When a request for the contents at the home is occurred in the cloud server 101 via the home gateway 102, the contents stored in the home network device 104, i.e., the camcorder are transmitted to the cloud server 101 via the network such as the internet.

Then, the cloud server 101 classifies the contents transmitted from a polarity of homes into a picture and a moving picture and generates contents group 503 for each of the picture and the moving picture according to the theme thereof and manages the operation of the storage and searching of the contents group 503.

Namely, the contents group 503 means that the contents collected from the home network device 140 is classified into a group according to a predetermined classification criterion. Thus, the user in the home can access the cloud server 101, input a keyword and search for the desired contents from the contents group 503. The contents searched for according to the keyword are transmitted to the display apparatus 110 of the home network device 104 installed at the home and thus the user can see the contents.

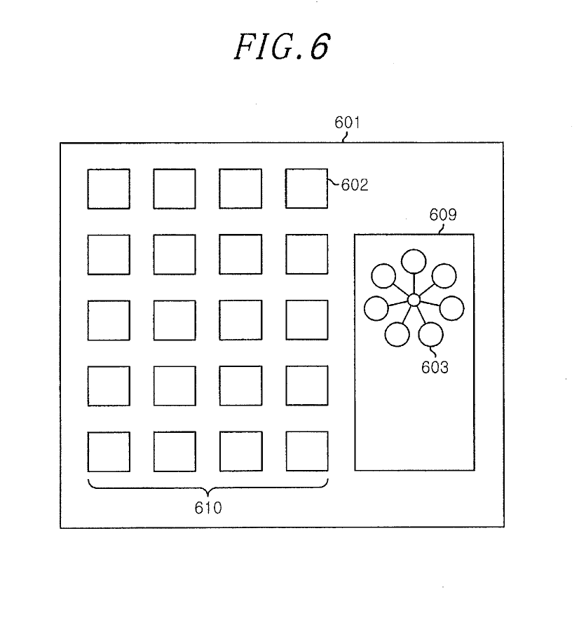

FIGS. 6 to 9 are examples of a user interface of a smart display 601 installed at home for searching for the contents managed in the cloud server 101 in accordance with the embodiment of the present invention.

Hereinafter, embodiments of the present invention will be described with reference to FIGS. 6 to 9.

FIG. 6 depicts a contents keyword status browser screen and a contents icon displayed in the screen.

A smart display apparatus 110 includes a contents keyword status browser 609 and a contents icon display 610. As shown in FIG. 6, keywords 603 for the contents group 503 stored and managed in the cloud server 101 are displayed and the contents icon 602 registered in the corresponding keyword 603 is displayed in the contents icon display 610.

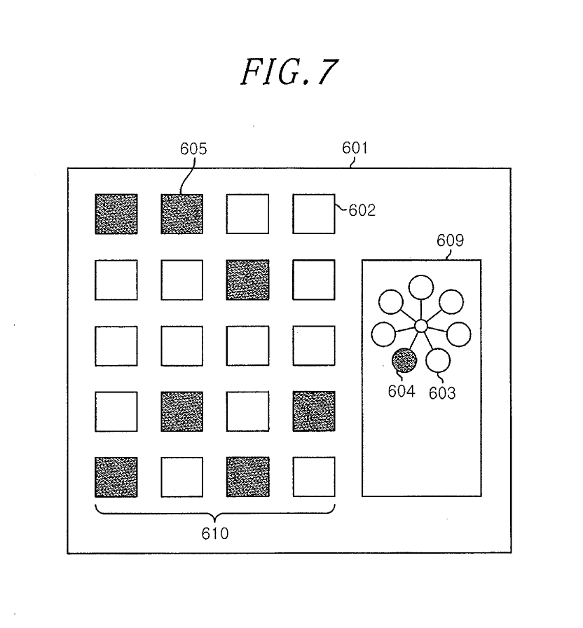

FIG. 7 is an example in case that a keyword among keywords displayed in the keyword status browser 609 is chosen in a user interface screen shown in FIG. 6 by a user.

Referring FIG. 7, when a keyword 604 among the keywords 603 displayed in the contents keyword status browser 609 is chosen, the contents icons 605 corresponding to the keyword 604 chosen by the user is displayed differently from general contents icon 602 (which does not correspond the keyword 604) in the contents icon display 610.

Thus, the user can identifies easily the contents icon expressing a desired contents group in the contents icon display 610 and can search for the contents registered in the contents icon by choosing the corresponding contents icon.

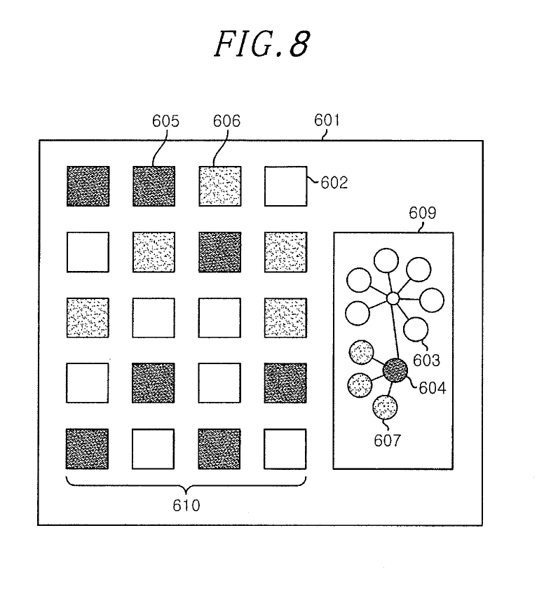

FIG. 8 shows an example in case that, when a specific keyword is chosen in the contents keyword status browser 609 of the user interface screen shown in FIG. 7 by the user, the corresponding keyword includes subordinate keyword.

When a specific keyword 604 is chosen firstly in the contents keyword status browser 609, contents icons 605 corresponding to the keyword 604 is displayed differently from the general contents icon 602. Here, in case that the firstly chosen keyword 604 has a subordinate keyword 607 in a tree structure, the subordinate keyword 607 is displayed in the contents keyword status browser 609 as shown in FIG. 8 and a contents icon 606 corresponding to the subordinate keyword 607 is additionally displayed in the contents icon display 610.

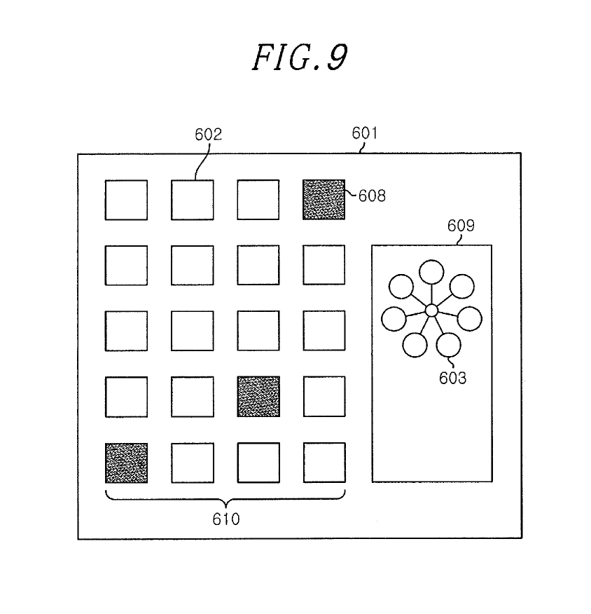

FIG. 9 shows an example of a user interface screen in case that a contents group 503 is added. In case that new contents group 503 is generated due to the addition of a contents classification in the cloud server 101, contents icon 608 corresponding to the new contents group 503 is displayed different from previous contents icon 602. Thus, the user can identify easily the addition of the new contents.

As described above, the unified management of contents generated in each home and an instant and seamless service can be implemented at home network service of a home network environment where a plurality of devices are installed by constructing a virtual smart home server based on a cloud computing in a complex server or a IDC center and providing the service of the home server operated stably by the professional management.

In addition, a home network service area can be extended by extending practical ability by connecting a home network construction to a cloud server and dividing execution of the service into a server and a client and providing a service execution device such as a smart phone with seamless operation.

While the invention has been shown and described with respect to the embodiments, it will be understood by those skilled in the art that various changes and modification may be made without departing from the scope of the invention as defined in the following claims.

What is claimed is:

1. A smart home system based on a cloud computing, comprising:
a home gateway connecting a home network device to an external network, the home network device being connected to a home network at each home; and
a cloud server, connected to the home gateway, for collecting contents information stored in the home network device and resource information of the home network information and performing a unified management of the contents information and the resource information at the each home.

2. A server apparatus based on a cloud computing, comprising:
a virtual home server for collecting contents information stored in a home network device and a resource information of the home network device from a home gateway connecting the home network device at home;
an overlay message module for receiving or transmitting the contents information or the resource information via the home gateway and an overlay messaging layer; and
a cloud server for controlling a cloud service, the cloud service performing a unified management of the contents information and the resource information transmitted from the virtual home server.

3. The server apparatus of claim 2, wherein the virtual home server includes:
a contents server for collecting the contents information stored in the home network device from the home gateway connecting the home network at the home;
a contents managing server for receiving the contents information stored at the home network device form the contents server and managing the contents information; and
a resource managing server for collecting the resource information of the home network device and managing the resource information.

4. A home gateway based on a cloud computing comprising:
a local service client for collecting contents information stored in a home network device connected to a home network at home and resource information of the home network device;
a home server for providing the contents information and the resource information collected from the local service client to a cloud server, the cloud server providing a cloud service;
an overlay message module for generating and transmitting to the cloud server an overlay message having the contents information and the resource information; and
a home networking module connected to the home network for interfacing data.

5. The home gateway of claim 4, wherein the contents information and the resource information managed in the cloud server are displayed on a display apparatus provided at the home.

6. The home gateway of claim 5, wherein the smart display module includes:
a contents keyword status browser for displaying a keyword which is used for searching for contents managed in the cloud server; and
a contents icon display for displaying a contents icon corresponding to a keyword chosen in the contents keyword status browser.

7. The home gateway of claim 6, wherein the contents keyword status browser displays the keyword in a tree structure.

8. The home gateway of claim 6, wherein the contents icon display displays a new icon differently from a previous contents icon when the new icon is added.

9. The home gateway of claim 4, wherein the local service client includes:
a contents client for collecting the contents information stored in the home network device;
a contents managing module for managing the contents information collected by the contents client; and
a resource managing module for collecting the resource information of the home network device and managing the resource information.

10. A smart home service method based on a cloud computing, comprising:
connecting a home network device to an external network by a home gateway, the home device being connected to a home network at home;
collecting a contents information stored in the home network device and a resource information of the home device by a cloud server implemented in the external network; and
performing a unified management of the collected contents information and the resource information.

11. The smart home service method of claim 10, wherein the collecting includes:
requesting a collection of the contents information stored in the home network device to the home gateway connecting the home device at the home;
collecting the contents information stored in the home network connected to the home network and the resource information of the home network by the home gateway; and
transmitting the contents information and the resource information to the cloud server.

12. The smart home service method of claim 10, wherein the contents information or the resource information is transmitted or received between the cloud server and the home gateway based on an overlay.
